(19) United States
(12) Patent Application Publication
(10) Pub. No.: US 2019/0053634 A1
(43) Pub. Date: Feb. 21, 2019

(54) THREE DIMENSIONAL POLYMERIC FIBER MATRIX LAYER FOR BEDDING PRODUCTS

(71) Applicant: SERTA SIMMONS BEDDING, LLC, Atlanta, GA (US)

(72) Inventors: Kevin Chirackal, Atlanta, GA (US); Mackenzie Prestera, Atlanta, GA (US); Sheri McGuire, Atlanta, GA (US); Brian Anderson, Atlanta, GA (US)

(21) Appl. No.: 15/679,400

(22) Filed: Aug. 17, 2017

(51) Int. Cl. A47C 27/22; A47C 27/15; A47C 21/04; D01F 6/62; D01F 6/60; D01F 6/46; D01F 1/10; B29C 70/22

(52) U.S. Cl. CPC A47C 27/22; A47C 27/15; A47C 21/046; D01F 6/62; D01F 6/60; D10B 2331/02; D01F 1/10; B29C 70/222; D10B 2321/021; D10B 2321/022; D10B 2331/04; D01F 6/46

(57) ABSTRACT

A layer for a bedding product such as a mattress includes an extruded three dimensional polymeric fiber matrix layer having constant length, width and height dimensions, the extruded three dimensional polymeric fiber matrix layer comprising randomly oriented fibers bonded at coupling points between adjacent fibers and having a free volume per unit area of the layer, wherein the fibers comprise a polymer and a phase change material.

### BACKGROUND

The present disclosure generally relates to bedding products and methods of manufacture, and more particularly, to bedding products including an extruded three-dimensional polymeric and phase change material fiber matrix layer.

One of the ongoing problems associated with all-foam mattress assemblies as well as hybrid foam mattresses (e.g., foam mattresses that include, in addition to one or more foam layers, spring coils, bladders including a fluid, and various combinations thereof) is user comfort. To address user comfort, mattresses are often fabricated with multiple layers having varying properties such as density and hardness, among others, to suit the needs of the intended user. One particular area of concern to user comfort is the level of heat buildup experienced by the user after a period of time. Additionally, some mattresses can retain a high level of moisture, further causing discomfort to the user and potentially leading to poor hygiene.

Unfortunately, the high density of foams used in current mattress assemblies, particularly those employing traditional memory foam layers that typically have fine cell structure and low airflow, generally prevents proper ventilation. As a result, the foam material can exhibit an uncomfortable level of heat to the user after a period of time.

In addition, the properties of the foam layers utilized in mattresses can change across the lifetime of owning the mattress, from the point of selecting the mattress until the mattress is eventually replaced. In particular, it has been noticed by consumers that the mattress they select when testing mattresses on the showroom floor may have a firmness that differs, at least somewhat, from the firmness of the mattress that ultimately is delivered to their home after they purchase the mattress. Commonly, the consumer finds that the mattress delivered to their home is more firm than the mattress they tested on the showroom floor. Additionally, over time the firmness of the mattress may change. As the consumer uses the mattress, the mattress may develop areas where the mattress is less firm than in other areas. Thus, over time the sleeping surface(s) of the mattress can have an inconsistent feeling, one where the firmness of the mattress varies or is perceived to vary.

Mattress manufacturers have circumvented this problem by educating the consumer about the nature of foam and informing them that they should expect the firmness of their newly purchased mattress to change over time. However, this approach fails to address the underlying reasons for the phenomenon and does not provide the consumer with a reliable estimate about how much the firmness of their new mattress is likely to change.

### BRIEF SUMMARY

Disclosed herein are bedding products such as a mattress including an extruded three-dimensional polymeric and phase change material fiber matrix layer.

In one or more embodiments, a layer for a bedding product includes an extruded three dimensional polymeric fiber matrix layer having constant length, width and height dimensions, the extruded three dimensional polymeric fiber matrix layer including randomly oriented fibers bonded at coupling points between adjacent fibers and having a free volume per unit area of the layer, wherein the fibers comprise a polymer and a phase change material.

In one or more embodiments, a mattress includes an extruded three dimensional polymeric fiber matrix layer having constant length, width and height dimensions, the extruded three dimensional polymeric fiber matrix layer including randomly oriented fibers bonded at coupling points between adjacent fibers and having a free volume per unit area of the layer, wherein the fibers comprise a polymer and a phase change material.

The disclosure may be understood more readily by reference to the following detailed description of the various features of the disclosure and the examples included therein.

### BRIEF DESCRIPTION OF THE SEVERAL VIEWS OF THE DRAWINGS

FIG. 1 schematically illustrates a partial cross sectional view of extruded three-dimensional polymeric and phase change material fiber matrix layer; and

FIG. 2 schematically illustrates an exemplary mattress including an extruded three-dimensional polymeric and phase change material fiber matrix layer.

### DETAILED DESCRIPTION

The present disclosure overcomes the problems noted in the prior art by providing a bedding product such as a mattress with one or more extruded three-dimensional polymeric matrix layers, wherein at least one of the extruded three dimensional polymeric fiber matrix layers includes a phase change material (PCM) coextruded therewith to provide an extruded three-dimensional polymeric and phase change material fiber matrix layer. Phase change materials (PCM) are substances that absorb and release thermal energy when the material switches from one phase to another phase. For example, when a PCM solidifies, e.g., freezes, it releases a large amount of energy in the form of latent heat at a relatively constant temperature. Conversely, when such material melts, it absorbs a large amount of heat from the environment. Advantageously, the PCM can be selected to provide improved cooling properties, which along with the free volume provided by the three dimensional fiber matrix markedly improves temperature management when used in a bedding product such as an all foam mattress.

As used in this disclosure, the term “bedding product” includes, without limitation, mattresses, pillows, mattress toppers, seat cushions and any product intended to cushion and support at least part of a person. It also includes like items made of memory foam such as that used in mattresses and pillows, such as lumbar supports, back supports, gaming chairs, ottomans, chair pads, benches and seats.

As will be discussed in greater detail below, the PCM is coextruded with a polymer to form an extruded three-dimensional polymeric and phase change material fiber matrix layer.

In one or more embodiments, suitable PCMs include, without limitation, microencapsulated PCMs and/or non-microencapsulated PCMs. The particular PCM for the microencapsulated PCMs and/or the non-microencapsulated PCMs is not intended to be limited and can be inorganic or organic. Suitable inorganic PCMs include salt hydrates made from natural salts with water. The chemical composition of the salts is varied in the mixture to achieve required phase-change temperature. Special nucleating agents can be added to the mixture to minimize phase-change salt separation. Suitable organic PCMs include fatty acids, waxes (e.g., paraffins) or the like.

With regard to microencapsulation, any of a variety of processes known in the art may be used to microencapsulate PCMs. One of the most typical methods which may be used to microencapsulate a PCM is to disperse droplets of the molten PCM in an aqueous solution and to form walls around the droplets using techniques such as coacervation, interfacial polymerization, or in situ polymerization, all of which are well known in the art. For example, the methods are well known in the art to form gelatin capsules by coacervation, polyurethane or polyurea capsules by interfacial polymerization, and urea-formaldehyde, urea-resorcinol-formaldehyde, and melamine formaldehyde capsules by in situ polymerization.

Encapsulation of the PCM creates a tiny, microscopic container for the PCM. This means that regardless of whether the PCM is in a solid state or a liquid state, the PCM will be contained. The size of the microcapsules typically range from about 1 to 100 microns and more typically from about 2 to 50 microns. The capsule size selected will depend on the application in which the microencapsulated PCM is used.

The microcapsules will typically have a relatively high payload of phase change material, typically at least 70% by weight, more typically at least 80% by weight, and in accordance with some embodiments, the microcapsules may contain more than 90% phase change material.

Gelling agents useful in the present disclosure include polysaccharides, nonionic polymers, inorganic polymers, polyanions and polycations. Examples of polysaccharides useful in the present disclosure include, but are not limited to, alginate and natural ionic polysaccharides such as chitosan, gellan gum, xanthan gum, hyaluronic acid, heparin, pectin and carrageenan. Examples of ionically crosslinkable polyanions suitable for use in the practice of the present invention include, but are not limited to, polyacrylic acid and polymethacrylic acid. Ionically crosslinkable polycations such as polyethylene imine and polylysine are also suitable for use in the present invention. A specific example of a non-ionic polymer is polyvinylalcohol. Sodium silicates are examples of useful inorganic polymers.

The gelling agents are typically provided as an aqueous solution at a concentration and viscosity sufficient to provide the desired amount of coating on the microcapsules. The technology of macroencapsulation is known to those skilled in the art as is the routine optimization of these parameters for the gelling agent.

Generally, the three dimensional PCM and polymeric fiber matrix layer is formed by co-extruding the desired three dimensional polymeric fibers along with the PCM, which can include microencapsulated and/or non-microencapsulated PCMs. Granules, pellets, chips, or the like of a desired polymer along with the desired PCM are fed into an extrusion apparatus, i.e., an extruder, at an elevated temperature and pressure, which is typically greater than the melting temperature of the polymer. The particular PCM is selected to be thermally stable during the extrusion process. The polymer, in melt form, and the PCM are then co-extruded through a die, which generally is a plate including numerous spaced apart apertures of a defined diameter, wherein the placement, density, and the diameter of the apertures can be the same or different throughout the plate. When different, the three dimensional PCM and polymeric fiber matrix layer can be made to have different zones of density, e.g., sectional areas can have different amounts of free volume per unit area. For example, the three dimensional PCM and polymeric fiber matrix layer can include a frame-like structure, wherein the outer peripheral portion has a higher density than the inner portion; or wherein the three dimensional PCM and polymeric fiber layer has a checkerboard-like pattern, wherein each square in the checkerboard has a different density than an adjacent square; or wherein the three dimensional PCM and polymeric fiber layer has different density portions corresponding to different anticipated weight loads of a user thereof. The various structures of the extruded three dimensional PCM and polymeric fiber and PCM matrix layer are not intended to be limited and can be customized for any desired application. In this manner, the firmness, i.e., indention force deflection, and/or density of the extruded three dimensional PCM and polymeric fiber matrix layer can be uniform or varied depending on the die configuration and conveyor speed.

The PCM and polymer is extruded into a cooling bath which results in entanglement and bonding of polymeric fibers through entanglement. Concurrently, the continuously extruded, cooled polymeric matrix is pulled onto a conveyor. The rate of conveyance and cooling bath temperature can be individually varied to further vary the thickness and density of the three dimensional PCM and polymeric fiber matrix layer. Generally, the thickness of the extruded three dimensional PCM and polymeric fiber matrix layer can be extruded as a full width mattress material at thicknesses ranging from about 1 to about 6 inches and can be produced to topper sizes or within roll form. However, thinner or thicker thicknesses could also be used as well as wider widths if desired. The extruded three dimensional PCM and polymeric matrix layer can have a thickness ranging from 0.5 to 5.9 inches.

Suitable extruders include, but are not limited to continuous process high shear mixers such as: industrial melt-plasticating extruders, available from a variety of manufacturers including, for example, Cincinnati-Millicron, Krupp Werner & Pfleiderer Corp., Ramsey, N.J. 07446, American Leistritz Extruder Corp.; Somerville, N.J. 08876; Berstorff Corp., Charlotte, N.C.; and Davis-Standard Div. Crompton & Knowles Corp., Paweatuck, Conn. 06379. Kneaders are available from Buss America, Inc.; Bloomington, Ill.; and high shear mixers alternatively known as Gelimat™ available from Draiswerke G.m.b.H., Mamnheim-Waldhof, Germany; and Farrel Continuous Mixers, available from Farrel Corp., Ansonia, Conn. The screw components used for mixing, heating, compressing, and kneading operations are shown and described in Chapter 8 and pages 458-476 of Rauwendaal, Polymer Extrusion, Hanser Publishers, New York (1986); Meijer, et al., “The Modeling of Continuous Mixers. Part 1: The Corotating Twin-Screw Extruder”, Polymer Engineering and Science, vol. 28, No. 5, pp. 282-284 (March 1988); and Gibbons et al., “Extrusion”, Modern Plastics Encyclopedia (1986-1987). The knowledge necessary to select extruder barrel elements and assemble extruder screws is readily available from various extruder suppliers and is well known to those of ordinary skill in the art of fluxed polymer plastication.

The polymer in the extruded three dimensional PCM and polymeric fiber matrix layer may be formed from polyesters, polyethylene, polypropylene, nylon, elastomers, copolymers and its derivatives, including monofilament or bicomponent filaments having different melting points. In one example, the polymer is an engineered polyester material. An exemplary polymer fiber structure according to this disclosure is a core polyester fibers that are sheathed in a polyester elastomer binder.

The extruded polymer fibers can be solid or hollow and have cross-sections that are circular or triangular or other cross sectional geometries, e.g. tri-lobular, channeled, and the like. Another type of polyester fiber has an entangled, spring-like structure. During manufacturing, the polymeric fiber structure is heated by extrusion to interlink the polymer fibers to one another to provide a more resilient structure. The polymer fibers may be randomly oriented or directionally oriented, depending on desired characteristics. Such processes are discussed in U.S. Pat. No. 8,813,286, entitled Tunable Spring Mattress and Method for Making the Same, the entirety of which is herein incorporated by reference.

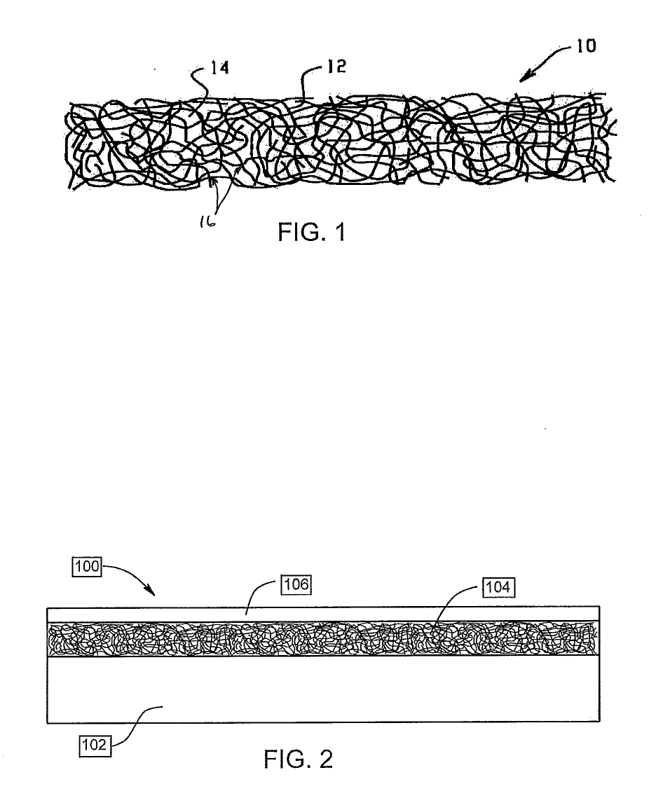

Turning now to FIG. 1, there is depicted an extruded three dimensional PCM and polymeric fiber matrix layer generally designated by reference numeral 10. The extruded three dimensional PCM and polymeric fiber matrix layer 10 includes randomly oriented polymer fibers 12 formed of the polymer and PCM defining a significant number of voids 14, i.e., a relatively large amount of free volume per unit area, wherein the free volume is defined as an area not occupied by a polymer strand and is also referred to herein as voids. The three dimensional polymeric fiber matrix layer 10 includes a plurality of bonding points 16 at points of intersection between the randomly oriented polymer fibers. At least a portion of the surfaces of the randomly oriented fibers are infused with the PCM.

The free volume of the extruded three dimensional PCM and polymeric fiber matrix layer is generally between about 50 percent and about 95 percent. In one or more other embodiments, the free volume of the extruded three dimensional PCM and polymeric fiber matrix layer is between about 60 percent and about 90 percent; and in still one or more other embodiments, the free volume is between about 70 percent and about 90 percent.

The extruded polymer fibers and their characteristics are selected to provide desired tuning characteristics. One measurement of “feel” for a cushion is the indentation-force-deflection, or IFD. Indentation force-deflection is a metric used in the flexible foam manufacturing industry to assess the “firmness” of a sample of foam such as memory foam. To conduct an IFD test, a circular flat indenter with a surface area of 323 square centimeters (50 sq. inches-8″ in diameter) is pressed against a foam sample usually 100 mm thick and with an area of 500 mm by 500 mm (ASTM standard D3574). The foam sample is first placed on a flat table perforated with holes to allow the passage of air. It then has its cells opened by being compressed twice to 75% “strain”, and then allowed to recover for six minutes. The force is measured 60 seconds after achieving 25% indentation with the indenter. Lower scores correspond with less firmness; higher scores with greater firmness. The IFD of the extruded three dimensional PCM and polymeric fiber matrix layer tested in this manner and configured for use in a mattress has an IFD ranging from 5 to 25 pounds-force. The density of the extruded three dimensional PCM and polymeric fiber matrix layer ranges from 1.5 to 6 lb/ft3.

FIG. 2 schematically illustrates a mattress 100 including a lower base layer 102, an extruded three dimensional PCM and polymeric fiber matrix layer 104, and at least one upper foam layer 106, wherein the extruded three dimensional PCM and polymeric fiber matrix layer 104 is intermediate to the base layer 102 and the upper foam layer 106.

Generally, the thickness of the lower base layer 102 is within a range of 4 inches to 10 inches, with a range of about 6 inches to 8 inches thickness in other embodiments, and a range of about 6 to 6.5 inches in still other embodiments. The lower base layer can be formed of open or closed cell foams, including without limitation, viscoelastic foams, latex foam, conventional polyurethane foams, and the like.

The lower base layer 102 can have a density of 1 pound per cubic foot (lb/ft3) to 6 lb/ft3. In other embodiments, the density is 1 lb/ft3 to 5 lb/ft3 and in still other embodiments, from 1.5 lb/ft3 to 4 lb/ft3. By way of example, the density can be about 1.5 lb/ft3. The indention force deflection (IFD), is within a range of 20 to 40 pounds-force, wherein the hardness is measured in accordance with ASTM D-3574.

Alternatively, the lower base layer 102 can be a coil spring innercore disposed within a cavity defined by a bucket assembly, wherein the bucket assembly includes a planar base layer and side rails disposed about a perimeter of the planar base layer.

The at least one upper foam layer 106 can define a cover panel overlying the extruded three dimensional PCM and polymeric fiber matrix layer 104. The cover panel can be formed from one or more viscoelastic foam and/or non-viscoelastic foam layers depending on the intended application. The foam itself can be of any open or closed cell foam material including without limitation, latex foams, natural latex foams, polyurethane foams, combinations thereof, and the like. The cover panel has planar top and bottom surfaces. The thickness of the cover panel is generally within a range of about 0.5 to 2 inches in some embodiments, and less than 1 inch in other embodiments so as to provide the benefits of motion separation and increased airflow from the underlying foam layer 104. As such, the extruded three dimensional PCM and polymeric fiber matrix layer 104 is proximate to the sleeping surface such that heat transfer can occur.

The density of the at least one upper foam layer 106 is within a range of 1 to 5 lb/ft3 in some embodiments, and 2 to 4 lb/ft3 in other embodiments. The hardness is within a range of about 10 to 20 pounds-force in some embodiments, and less than 15 pounds-force in other embodiments. In one embodiment, the cover panel is at a thickness of 0.5 inches, a density of 3.4 lb/ft3, and a hardness of 14 pounds-force.

The various multiple stacked mattress layers 102, 104, and 106 may be adjoined to one another using an adhesive or may be thermally bonded to one another or may be mechanically fastened to one another as may be desired for different applications.

Optionally, one or more of the layers 102, 104, and 106 can be pre-conditioned, wherein the layer or layers are compressed or stretched to break and/or open closed cells in the case of a foam layer or break bonds or polymer fibers in the case of the extruded three dimensional polymeric fiber matrix layer. The preconditioning can be in accordance with the processes generally disclosed in U.S. Pat. No. 7,690,096, incorporated herein by reference in its entirety.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A layer for a bedding product, comprising:
an extruded three dimensional polymeric fiber matrix layer having constant length, width and height dimensions, the extruded three dimensional polymeric fiber matrix layer comprising randomly oriented fibers bonded at coupling points between adjacent fibers and having a free volume per unit area of the layer, wherein the fibers comprise a polymer and a phase change material coextruded therein.

2. The layer of claim 1, wherein the phase change material is selected from the group consisting of fatty acids, waxes, and salt hydrates.

3. The layer of claim 1, wherein the phase change material is microencapsulated.

4. The layer of claim 2, wherein the microencapsulated phase change material has at least a 70 percent loading by weight based on a total weight of a microcapsule and the phase change material therein.

5. The layer of claim 1, wherein the polymer is selected from the group consisting of polyesters, polyethylene, polypropylene, nylon, elastomers, copolymers and its derivatives, including monofilament or bicomponent filaments having different melting points.

6. The layer of claim 1, wherein the extruded three dimensional polymeric fiber matrix layer comprises multiple zones having different densities and/or indention force deflection values,

7. The layer of claim 1, wherein the three dimensionally polymeric fiber matrix layer has a free volume greater than 50 percent by per unit area of the layer weight and is at a thickness between 1 inch and 6 inches.

8. The layer of claim 1, wherein the extruded three dimensional polymeric fiber matrix layer has an indention force deflection ranging from 5 to 25 pounds-force.

9. A mattress comprising:
an extruded three dimensional polymeric fiber matrix layer having constant length, width and height dimensions, the extruded three dimensional polymeric fiber matrix layer comprising randomly oriented fibers bonded at coupling points between adjacent fibers and having a free volume per unit area of the layer, wherein the fibers comprise a polymer and a phase change material coextruded therein.

10. The mattress of claim 9, further comprising at least one upper foam layer and a lower base layer, wherein the extruded three dimensional polymeric fiber matrix layer is intermediate at least one upper foam layer and a lower base layer.

11. The mattress of claim 10, wherein the at least one upper foam layer comprises a viscoelastic foam.

12. The mattress of claim 10, wherein the lower base layer comprises a polyurethane foam or a latex foam.

13. The mattress of claim 9, wherein the phase change material is microencapsulated.

14. The mattress of claim 9, wherein the phase change material is selected from the group consisting of fatty acids, waxes, and salt hydrates.

15. The mattress of claim 13, wherein the microencapsulated phase change material has at least a 70 percent loading by weight based on a total weight of a microcapsule and the phase change material therein.

16. The mattress of claim 9, wherein the polymer is selected from the group consisting of polyesters, polyethylene, polypropylene, nylon, elastomers, copolymers and its derivatives, including monofilament or bicomponent filaments having different melting points.

17. The mattress of claim 9, wherein the extruded three dimensional polymeric fiber layer comprises multiple zones of the polymer fibers having different densities and/or indention force deflection values,

18. The mattress of claim 9, wherein the extruded three dimensional polymeric fiber matrix layer has a free volume greater than 50 percent per unit area of the layer and is at a thickness between 1 inch and 6 inches.

19. The mattress of claim 9, wherein the extruded three dimensional polymeric fiber matrix layer has an indention force deflection ranging from 5 to 25 pounds-force

20. The mattress of claim 10, wherein the base layer comprises a polyurethane foam, a latex foam; a polystyrene foam, polyethylene foam, a polypropylene foam, or a polyether-polyurethane foam.
